(19) United States
(12) Patent Application Publication
(10) Pub. No.: US 2017/0350079 A1
(43) Pub. Date: Dec. 7, 2017

(54) ASPHALT PAVEMENT MATERIAL FOR COLD LAYING

(71) Applicant: Hikari-Kogyo Co., Ltd., Kyoto (JP)

(72) Inventor: Terutaka Kitagawa, Kyoto (JP)

(21) Appl. No.: 15/615,210

(22) Filed: Jun. 6, 2017

(30) Foreign Application Priority Data
Jun. 6, 2016 (JP) P2016-112518

(51) Int. Cl. E01C 7/20; C08L 95/00; E01C 7/18; E01C 11/24

(52) U.S. Cl. CPC E01C 7/20; E01C 11/24; C08L 95/005; E01C 7/182

(57) ABSTRACT

With respect to the overall cold asphalt pavement material, ≧1.0 wt. % of gypsum hemi-hydrate is added to a cold asphalt pavement material to improve the stability and workability of cold asphalt pavement materials.

### RELATED APPLICATIONS

This application claims priority to Japanese Patent Application No. P2016-112518, filed on Jun. 6, 2016, and titled “Asphalt Pavement Material for Cold Laying.”

### BACKGROUND

### Technical Field

The present invention relates to a cold asphalt pavement material that enables pavement work at normal temperatures.

### Description of the Related Art

While cold asphalt pavement materials are advantageous over hot asphalt pavement materials in that pavement may be laid easily at normal temperatures, they are problematic in that the pavement has inferior strength in comparison to hot asphalt pavement materials. Cold asphalt pavement materials are further problematic in that pavement work is impossible under conditions in which water exists, e.g., when it rains, etc., because the pavement strength deteriorates when water is mixed in during the work.

Related prior documents include the following patent documents: Japanese Unexamined Patent Application Publication No. 2010-077780; Japanese Unexamined Patent Application Publication No. S60-009057; and Japanese Unexamined Patent Application Publication No. 2005-219965. Related prior documents also include the following non-patent document: “Applicability of Recycled Gypsum to Asphalt Mixed Filler Materials,” Chikashi Koga, et/al, JOURNAL OF JAPAN SOCIETY OF CIVIL ENGINEERING E1 (Pavement Engineering), vol. 69, No. 3 (Journal of Pavement Engineering Vol. 18), I_95-I_100, 2013, Academic Literature (hereinafter, “the Koga article”).

### BRIEF SUMMARY

### Problem to be Solved by the Invention

The present inventors examined the idea of adding gypsum hemi-hydrate to a cold asphalt pavement material for the purpose of solving such problems with regard to cold asphalt pavement materials.

As a result, the present inventors first discovered that the strength of pavement with a cold asphalt pavement material improves by adding gypsum hemi-hydrate to the cold asphalt pavement material. The present invention was completed based on this finding.

It should be noted that the above-noted Japanese Unexamined Patent Application Publication Nos. 2010-077780, S60-009057, and 2005-219965, and the Koga article describe a hot asphalt pavement material to which anhydrous gypsum, gypsum dihydrate, and gypsum hemi-hydrate are added as fillers. The whole purpose of these documents is nothing more than the recycling of gypsum, and the study does not go beyond the possible use of gypsum as an alternative to stone powder which is generally a filler with regard to hot asphalt pavement materials.

Moreover, Japanese Unexamined Patent Application Publication No. 2010-077780 and the Koga article imply cases in which the use of gypsum hemi-hydrate as the filler lowers the degree of stability, which is one of the indexes of pavement strength.

That is, ≧1.0 wt. % of gypsum hemi-hydrate is added with respect to the overall cold asphalt pavement material in the cold asphalt pavement material pertaining to the present invention.

If such a cold asphalt pavement material is used, when water is added during pavement work, gypsum hemi-hydrate absorbs the water, converts into gypsum dihydrate, and solidifies. Because the solidified gypsum dihydrate is a highly rigid substance having a stability that is different from highly flexible asphalt, combining two types of solidifying factors, i.e., gypsum dihydrate and asphalt, enhances the strength of the pavement far more than conventional pavement in which asphalt is the only solidifying factor therein.

Furthermore, for example, even if pavement work is conducted under conditions in which water exists when it rains, etc., the water is absorbed by the added gypsum hemi-hydrate, making it possible to reduce the fragility of the pavement surface resulting from the water mixed in during the pavement work.

As a concrete embodiment of the present invention, a cold asphalt pavement material to which 1.0 wt. % to 50.0 wt. % of gypsum hemi-hydrate is added with respect to the overall cold asphalt pavement material may be cited.

As a more concrete embodiment of the present invention, a cold asphalt pavement material mixed with gypsum hemi-hydrate and a cold asphalt mixture containing 1.5 wt. %-12.0 wt. % asphalt, 70.0 wt. %-95.0 wt. % aggregate, 1.0 wt. %-10.0 wt. % filler, and 0.5 wt. %-3.5 wt. % softener may be cited.

According to pavement work using such a cold asphalt pavement material pertaining to the present invention described above, when water is added during pavement work, gypsum hemi-hydrate solidifies, making it possible to lay stronger pavement in comparison to cold asphalt pavement materials in which asphalt is the only solidifying factor therein.

Moreover, pavement work becomes possible under conditions in which water exists such as when it rains, etc.

### Effects of the Invention

According to the cold asphalt pavement material pertaining to the present invention, when water is added during pavement work, gypsum hemi-hydrate absorbs the water, converts into gypsum dihydrate, and solidifies. Because the solidified gypsum dihydrate is a highly rigid substance having stability that is different from highly flexible asphalt, combining two types of solidifying factors, i.e., gypsum dihydrate and asphalt, enhances the strength of pavement far more than conventional pavements in which asphalt is the only solidifying factor therein.

Furthermore, for example, even if pavement work is conducted under conditions in which water exists when it rains, etc., the water is absorbed by the added gypsum hemi-hydrate, making it possible to reduce the fragility of the pavement surface due to water mixed in during the pavement work.

### DETAILED DESCRIPTION

Here, one embodiment of the present invention will be described.

The cold asphalt pavement material in the present invention is, for example, a cold asphalt pavement material that enables pavement work at normal temperatures, for example, at the time of paving or repairing a road surface, etc.

The aforementioned cold asphalt pavement material is a mixture of gypsum hemi-hydrate mixed with a cold asphalt mixture that contains asphalt, aggregate, filler, and softener, etc., enabling pavement work at normal temperatures.

Regarding the aforementioned asphalt, straight asphalt (hereinafter, simply referred to as asphalt) is used and regulated such that the final content of the asphalt is, for example, 5.0 wt. %-6.0 wt. % with respect to the overall mixture of cold asphalt.

Asphalt with a penetration of 60 to 80 may be cited as an example of the asphalt to be added when required.

The aforementioned aggregate refers to a mixture of coarse aggregate (aggregate that remains at 85% or more in weight when sifted through a sieve of 5 mm) and fine aggregate (all of the aggregate can be sifted through a sieve of 10 mm, with 85% or more passing through a 5 mm sieve), or an aggregate containing only the fine aggregate.

In the present embodiment, an aggregate (only the fine aggregate) is added, for example, so as to be 87.0 wt. %-88.0 wt. %.

The aforementioned filler is for filling in the gaps among the aggregate at the time of pavement work and is, for example, a fine powder, etc. of calcium carbonate (Ca Co₃) which is generally referred to as stone powder.

The filler is added so as to be 3.0 wt. %-6.0 wt. % with respect to the overall cold asphalt mixture.

The softener is for maintaining the asphalt in a soft state, preventing the asphalt from being solidified under normal temperatures, and is, for example, a volatile petroleum-based hydrocarbon.

The softener is added so as to be, for example, 1.0 wt. %-2.5 wt. % with respect to the overall cold asphalt mixture.

The cold asphalt pavement material is a mixture of, for example, 20.0 wt. % of gypsum hemi-hydrate and 80.0 wt. % of the aforementioned cold asphalt mixture with respect to the overall cold asphalt pavement material.

The manufacturing procedure of the cold asphalt pavement material is, for example, as follows.

A hot asphalt mixture is produced by mixing a filler into a heated aggregate and subsequently adding heated asphalt as required by mixing and kneading so as to cause the asphalt to adhere to the surface of the aggregate.

To produce a cold asphalt mixture that enables pavement work at normal temperatures, a compatible softener is added to the asphalt in the hot asphalt mixture so as to be further mixed and kneaded, causing the asphalt to be softened while preventing the asphalt adhering to the surface of the aggregate from being solidified to a certain extent even if the temperature drops.

The cold asphalt mixture produced in this manner is mixed with gypsum hemi-hydrate.

The method of pavement work using the cold asphalt pavement material is exemplarily described below.

First, an appropriate amount of bagged cold asphalt pavement material, etc. is poured, for example, into cracks or steps formed on a road surface, sites where pavement repairs are needed such as pot holes, etc., and sites where asphalt pavement is required such as roads, etc.

Next, an appropriate amount of water is sprinkled over the cold asphalt pavement material and the cold asphalt pavement material is pressed so as to be compacted using a rotary compactor, etc.

Once the cold asphalt pavement material is pressed and compacted, the pavement surface must be allowed to rest until stabilized before completing the pavement work.

During pavement work, the amount of water to be added to the cold asphalt pavement material may be any as long as the amount is greater than the necessary amount required for solidification caused by the hydration reaction of gypsum hemi-hydrate that has been added to the cold asphalt pavement material, and is appropriately determined in accordance with the ratio of gypsum hemi-hydrate that has been added to the cold asphalt pavement material, the weather conditions, etc.

According to such a cold asphalt pavement material, because gypsum hemi-hydrate is, for example, 20.0 wt. % mixed in with respect to the overall cold asphalt pavement material, etc., even if pavement work is conducted under conditions in which water exists, such as when it rains, gypsum hemi-hydrate absorbs the water, enabling a reduction in the fragility of the pavement surface created by the mixed-in water.

Furthermore, gypsum hemi-hydrate possesses the property to convert to gypsum dihydrate once water is absorbed and solidifies. Because the solidified gypsum dihydrate is a highly rigid substance having stability that is different from highly flexible asphalt, by combining two types of solidifying factors, i.e., gypsum dihydrate and asphalt, it becomes possible to enhance the strength of the pavement in comparison to conventional cold asphalt pavement materials in which asphalt is the only solidifying factor.

Adding, for example, 20.0 wt. % of gypsum hemi-hydrate with respect to the overall cold asphalt pavement material helps keep the fluidity of cold asphalt pavement materials when laying pavement within an appropriate range, realizing a cold asphalt pavement material with favorable workability.

Because the gypsum hemi-hydrate is mixed in after first producing a cold asphalt mixture, the flexibility and rigidity essentially found in cold asphalt mixtures and gypsum hemi-hydrate are maintained in comparison to the case in which gypsum hemi-hydrate is added in the middle of producing a cold asphalt mixture, creating a workable combination.

Furthermore, the present invention is not limited to the aforementioned embodiment.

In the aforementioned embodiment, 20 wt. % of the gypsum hemi-hydrate is added with respect to the overall cold asphalt pavement material; however, the amount of gypsum hemi-hydrate to be added is not restricted to 20 wt. %, but may also be more or less.

The amount may be any as long as 1.0 wt. % or greater is added with respect to the overall cold asphalt pavement material; for example, the amount of the gypsum hemi-hydrate to be added may be, 1.5 wt. % or greater.

If the amount of the gypsum hemi-hydrate to be added with respect to the overall cold asphalt pavement material is smaller, the flexibility of the cold asphalt pavement material relatively increases, resulting in an increase in the hardness of the cold asphalt pavement material as the adding amount of the gypsum hemi-hydrate increases.

Therefore, the hardness of the cold asphalt pavement material may be adjusted as necessary by appropriately adding gypsum hemi-hydrate within a range of 1.0 wt. %-95.0 wt. %.

Furthermore, if the cold asphalt pavement material includes 3.0 wt. % of greater gypsum hemi-hydrate that has been added therein, the stability sufficiently exceeding a reference value of 4.9 kN for hot asphalt pavement may be realized in terms of the Marshall stability, which is one of indexes of asphalt pavement strength.

Any added amount of gypsum hemi-hydrate exceeding 30.0 wt. % may yield a cold asphalt material with sufficiently high stability.

If the ratio of gypsum hemi-hydrate with respect to the overall cold asphalt pavement material is less than 15.0 wt. %, adding gypsum hemi-hydrate helps keep the fluidity of the cold asphalt pavement material within an appropriate range at the time of pavement work, further improving the workability of the cold asphalt pavement material.

Moreover, if the amount of gypsum hemi-hydrate to be added is less than 15.0 wt. % with respect to the overall cold asphalt pavement material, increased costs resulting from adding the gypsum hemi-hydrate may be controlled within an appropriate range.

The range of the ratio of gypsum hemi-hydrate to be added does not have to be the abovementioned range, with the following ratios also possible: 1.0 wt. %-3.0 wt. %, 1.0 wt. %-10.0 wt. %, 1.0 wt. %-20.0 wt. %, 1.0 wt. %-30.0 wt. %, 1.0 wt. %-50.0 wt. %, 3.0 wt. %-10.0 wt. %, 3.0 wt. %-15.0 wt. %, 3.0 wt. %-20.0 wt. %, 3.0 wt. %-30.0 wt. %, 3.0 wt. %-50.0 wt. %, 3.0 wt. %-95.0 wt. %, 5.0 wt. %-10.0 wt. %, 5.0 wt. %-15.0 wt. %, 5.0 wt. %-20.0 wt. %, 5.0 wt. %-30.0 wt. %, 5.0 wt. %-50.0 wt. %, 5.0 wt. %-95.0 wt. %, 10.0 wt. %-15.0 wt. %, 10.0 wt. %-20.0 wt. %, 10.0 wt. %-30.0 wt. %, 10.0 wt. %-50.0 wt. %, 10.0 wt. %-95.0 wt. %, 15.0 wt. %-20.0 wt. %, 15.0 wt. %-30.0 wt. %, 15.0 wt. %-50.0 wt. %, 15.0 wt. %-95.0 wt. %, 20.0 wt. %-30.0 wt. %, 20.0 wt. %-50.0 wt. %, 20.0 wt. %-95.0 wt. %, 30.0 wt. %-50.0 wt. %, 30.0 wt. %-95.0 wt. %, or 50.0 wt. %-95.0 wt. %.

The aggregate and asphalt do not have to be new aggregate or new asphalt, but may have a recycling material added thereto, or may also be comprised solely of recycling materials.

Herein, recycling materials refer to, for example, materials generated from digging pavement or materials pulverized at normal temperatures to an extent such that asphalt adheres to the surface of aggregates.

The cold asphalt mixture is not necessarily limited to cold asphalt mixtures that may be used for pavement work at normal temperatures by adding a softener after producing a hot asphalt mixture, but may also be products produced from adding a softener to a recycling material under normal temperatures.

The aforementioned asphalt is not necessarily limited to asphalt ranging from 5.0 wt. %-6.0 wt. % with respect to the overall cold asphalt mixture as long as the asphalt is mixed and added so as to be 1.5 wt. %-12.0 wt. %.

Regarding the asphalt to be used when producing the cold asphalt mixture, any asphalt with a penetration of 40-60, 60-80, 80-100, or 150-200 may be used, with asphalt having a penetration of 40-60 or greater than 60, more preferably 60-80, particularly suitable for road pavement work; however, if the ratio of recycling material to be used is high, asphalt with high penetration such as 80-100 or 150-200, etc. is suitable, while if the ratio of new aggregate to be used is high, asphalt with lower penetration is more suitable.

As described, because asphalt with a wide penetration range is used, not only new aggregate but also recycling materials may also be used as the raw material, enabling a further increase in the amount of recycling material to be used.

As long as the aggregate is added within a range of 70.0 wt. %-95.0 wt. % with respect to the overall cold asphalt mixture, the amount to be added is not necessarily limited to 87.0 wt. %-88.0 wt. %.

As long as the filler is added within a range of 1.0 wt. %-10.0 wt. % with respect to the overall cold asphalt mixture, the amount to be added is not necessarily limited to 4.0 wt. %-6.0 wt. %, and it is particularly preferable to add the filler within a range of 4.0 wt. %-7.0 wt. %.

The aforementioned softener is not necessarily limited to petroleum-based hydrocarbons but may also be an animal/vegetable oil or synthetic hydrocarbon or synthetic ester-based oil; however, petroleum-based hydrocarbons are unlikely to change their nature and are also preferable in terms of the excellent cost thereof.

As long as the softener is added within a range of 0.5 wt. %-3.5 wt. % with respect to the overall cold asphalt mixture, the amount to be added is not necessarily limited to 1.0 wt. %-1.5 wt. %.

In addition to the aforementioned components, for example, resin, etc. may also be added to the cold asphalt mixture to maintain an appropriate viscosity.

Furthermore, for example, approximately 0.01 wt. %-0.1 wt. % of carbon black, etc. may also be added to the cold asphalt pavement material or a cold asphalt mixture in order to adjust the final color.

Additionally, the present invention is not limited to the above embodiment and various modifications are possible within the scope of the claims.

### Embodiment

The present invention is described in further detail using the following embodiment; however, the present invention is not limited to this embodiment.

The results of testing regarding the cold asphalt pavement material pertaining to the present invention according to Marshall stability testing have been summarized in Table 1.

This testing measures the stability of testing pieces that have undergone tamping by employing a tamping method included in the Marshall stability testing.

According to the provisions of the Marshall stability testing, stability is measured when a testing piece is in a heated state at 60° C.; however, the cold asphalt pavement material pertaining to the present invention was tamped at normal temperature taking into consideration the characteristics of cold laying, and the Marshall stability was measured at normal temperature after 24 hours of curing time at room temperature.

Furthermore, the stability of Table 1 is the stability prescribed in Marshall stability testing in units of kN (kilo Newtons).

Furthermore, 100 cc of water was added to testing pieces of 1 kg at the time of tamping.

The cold asphalt pavement material used for testing pieces in this embodiment was a mixture of gypsum hemi-hydrate of different proportions and a cold asphalt mixture mixed at ratios of 6.0 wt. % asphalt, 89.0 wt. % aggregate, 4.0 wt. % filler, and 1.0 wt. % softener with respect to the overall cold asphalt mixture.

The ratio of gypsum hemi-hydrate in the table represents the wt. % of gypsum hemi-hydrate that has been mixed with respect to the overall cold asphalt pavement material.

Testing was conducted three times each with respect to the testing pieces at different mixing ratios of gypsum hemi-hydrate, with the average value of the three Marshall stability tests represented as the stability.

TABLE 1

| Gypsum | Stability |
|---|---|
| hemi-hydrate (%) | (kN) |
| 0 | 2.34 |
| 3 | 5.90 |
| 5 | 7.63 |
| 10 | 9.02 |
| 20 | 13.53 |
| 30 | Unmeasurable |
| 40 | Unmeasurable |
| 50 | Unmeasurable |

The results in Table 1 indicate a significant stability increase of more than double in the testing pieces to which 3.0 wt. % to 20.0 wt. % of gypsum hemi-hydrate had been added with respect to the overall cold asphalt pavement material in comparison to a cold asphalt pavement material that was comprised solely of a cold asphalt mixture with no added gypsum hemi-hydrate, with the stability increasing as the mixing ratio of gypsum hemi-hydrate increased.

Furthermore, every testing piece in which gypsum hemi-hydrate had been added far exceeded the reference value of 4.9 kN which was a reference value of the Marshall stability in the case of hot asphalt pavement materials.

Moreover, the stability value could not be measured for testing pieces that had more than 30.0 wt. % or a greater ratio of gypsum hemi-hydrate because the stability was too high and beyond the range of the measuring gauge.

Table 2 represents the results of testing conducted in accordance with the immersion Marshall testing with respect to the testing pieces formed as in the testing of Table 1.

In the immersion Marshall testing, the Marshall stability was measured after the testing pieces were immersed in a water tank for 48 hours at a temperature of 60° C.; however, taking into consideration the characteristics of the cold asphalt pavement material for cold laying pertaining to the present invention, after the testing pieces were immersed in a water tank for 48 hours at 20° C., the Marshall stability was measured. Three tests were conducted with regard to each testing piece and the average value was given as the stability.

TABLE 2

| Gypsum hemi-hydrate (%) | Stability (kN) |
|---|---|
| 0 | 2.34 |
| 10 | 5.12 |
| 20 | 8.73 |

The results in Table 2 indicate that the stability of testing pieces to which 10.0 wt. % to 20.0 wt. % of gypsum hemi-hydrate had been added with respect to the overall cold asphalt pavement material more than doubled in comparison to a cold asphalt pavement material that was comprised solely of a cold asphalt mixture with no added gypsum hemi-hydrate, with the stability increasing as the mixing ratio of the gypsum hemi-hydrate increased.

Furthermore, Table 3 indicates the results of a wheel tracking test conducted under conditions of 60° C. with regard to the testing pieces formed via the same technique as the testing in Table 1 using testing pieces to which 10.0 wt. % of gypsum hemi-hydrate was added with respect to the overall cold asphalt pavement material, and the results were compared to the reference value of a hot asphalt pavement material composed of straight asphalt or modified asphalt.

TABLE 3

| | Dynamic stability (number |
|---|---|
| | of times/mm) |
| Results of 10% gypsum hemi-hydrate | 10500 |
| Straight asphalt reference value | 1000 |
| Modified asphalt reference value | 3000 |

It is clear from Table 3 that the testing pieces to which 10.0 wt. % of gypsum hemi-hydrate had been added with respect to the overall cold asphalt pavement material showed a dynamic stability of greater than 10-fold in comparison to the reference value of the straight asphalt and 3.5-fold the reference value of the modified asphalt.

From the above testing results described thus far, it has been confirmed that the cold asphalt pavement material pertaining to the present invention in which gypsum hemi-hydrate has been mixed shows a significant improvement in stability compared to a cold asphalt pavement material comprised solely of a cold asphalt mixture to which gypsum hemi-hydrate has not been added.

1. A cold asphalt pavement material comprising gypsum hemi-hydrate in an amount 1.0 wt. % of the overall material weight.

2. The cold asphalt pavement material of claim 1, wherein the amount of said gypsum hemi-hydrate is between 1.0 wt. % and 50.0 wt. %; the amount of asphalt is between 1.5 wt. % and 12 wt. %; and the amount of aggregate is between 70.0 wt. % and 95.0 wt. % of the overall material weight.

3. The cold asphalt pavement material of claim 2, wherein the aggregate is a mixture of coarse aggregate and fine aggregate, wherein 85% of the coarse aggregate by weight remains when sifted through a 5 mm sieve, and all of the fine aggregate can be sifted through a sieve of 10 mm and 85% or more of the fine aggregate passes through a 5 mm sieve.

4. The cold asphalt pavement material of claim 1, further comprising filler in an amount between 1.0 wt. % and 10.0 wt. % of the overall material weight.

5. The cold asphalt pavement material of claim 1, further comprising a softener.

6. The cold asphalt pavement material of claim 1, wherein the softener is compatible with a hot asphalt mixture.

7. The cold asphalt pavement material of claim 5, wherein the softener is selected from a group comprising one or more of a petroleum-based hydrocarbon, an animal oil, a vegetable oil, a synthetic hydrocarbon, and a synthetic ester-based oil.

8. The cold asphalt pavement material of claim 1, further comprising added water.

9. The cold asphalt pavement material of claim 7, wherein the material in a solidified condition includes gypsum dihydrate and has a Marshall stability value of at least 4.9 kN.

10. The cold asphalt pavement material of claim 2, wherein at least one of the aggregate and asphalt includes a recycled material.

11. The cold asphalt pavement material of claim 1, further comprising resin.

12. A cold asphalt pavement material comprising gypsum dihydrate and asphalt.

13. The cold asphalt pavement material of claim 12, wherein the gypsum dihydrate and asphalt are solidified.

14. The cold asphalt pavement material of claim 12, wherein the material has a Marshall stability value of at least 4.9 kN.

15. The cold asphalt pavement material of claim 12, further comprising added water.

16. The cold asphalt material of claim 15, wherein the gypsum dihydrate comprises gypsum hemihydrate and water, and the gypsum hemihydrate is present in an amount≧1.0 wt. % of the total weight of the material, which does not include the weight of added water.

17. The cold asphalt pavement material of claim 16, wherein the amount of said gypsum hemi-hydrate is between 1.0 wt. % and 50.0 wt. %; the amount of asphalt is between 1.5 wt. % and 12 wt. %; and the amount of aggregate is between 70.0 wt. % and 95.0 wt. % of the overall material weight, which does not include the weight of added water.

18. The cold asphalt pavement material of claim 17, wherein the amount of said gypsum hemi-hydrate is 10.0 wt. %.

19. The cold asphalt pavement material of claim 12, further comprising a softener.

20. The cold asphalt pavement material of claim 12, wherein the softener is compatible with a hot asphalt mixture.
